(19) United States
(12) Patent Application Publication
(10) Pub. No.: US 2009/0210390 A1
(43) Pub. Date: Aug. 20, 2009

(54) ASSET ADVISER INTELLIGENCE ENGINE FOR MANAGING REUSABLE SOFTWARE ASSETS

(75) Inventor: Eoin Lane, Littleton, MA (US)

Correspondence Address: IBM Corporation (Endicott);c/o Ortiz & Lopez, P.O. Box 4484, Albuquerque, NM, 87196-4484, US

(73) Assignee: International Business Machines Corporation

(21) Appl. No.: 12/034,508

(22) Filed: Feb. 20, 2008

(51) Int. Cl. G06F 17/30

(52) U.S. Cl. 707/3; 707/E17.014

(57) ABSTRACT

A computer implemented method, system and computer program product for managing reusable software assets based on software requirements. A topic map can be expressed utilizing semantic web technology in order to model a relationship between a software requirement and a reusable software asset. The relationship includes the software assets needed to satisfy the software requirement, relationship between the software assets, and the location of the software assets. The semantic web representation can then leverage a standard web based query mechanism to allow meaningful queries to suggest best software assets to be utilized with the software requirement. The semantic web representation can also leverage standard XML (extensible markup language) tooling to provide consistence checking and inferencing of new data.

### TECHNICAL FIELD

Embodiments are generally related to data-processing systems and methods. Embodiments also relate in general to the field of computers and similar technologies, and in particular to software utilized in this field. In addition, embodiments relate to methods and systems for managing reusable software assets.

### BACKGROUND OF THE INVENTION

Software frameworks offer sets of reusable and adaptable components embedded within an architecture optimized for a given target domain. A software asset generally refers to a set of one or more related artifacts that have been created or harvested for the purpose of applying the asset repeatedly in subsequent development environments. Source code and binary code are examples of artifacts adapted for use with the software assets. Other examples of artifacts include related documentation, such as requirement specifications, design documents, operation manuals, and the like. Additional examples of artifacts include models, such as process models, structural models, resource models, implementation models, and so forth, which may additionally include object models, collaboration diagrams, deployment models, etc.

Reusable software assets can be utilized to address both functional and nonfunctional requirements. Functional requirements define what a particular piece of software can be expected to accomplish. Non-functional requirements (NFRs) specify global constraints that must be satisfied by the software. These constraints, also known as software global attributes, typically include performance, fault-tolerance, availability, security and so on. During a software development process, the functional requirements are usually incorporated into software artifacts and can be implemented in such a manner that the software satisfies the functional requirements defined at the early stages.

The NFRs, however, are not implemented in the same manner as functional requirements. The NFRs are more complex to deal with and are usually very abstract and provided only informally, and rarely supported by tools, methodologies or languages. Similarly, it is not trivial to verify whether or not a specific NFR can be satisfied by a final product, and very often NFRs conflict with each other. The NFRs commonly concern environment builders instead of application programmers.

SOA (Service Oriented Architecture) is the practice of sequestering core business functionalities into independent services that do not change frequently. The architectural decisions in software labs or with respect to engagements do not provide architectural consistency, tractability or accountability in terms of the decisions made. The architectural decisions are driven by non-functional requirements such as performance, transactionality, tractability, scalability, etc. Because software assets are not currently cataloged against meaningful criteria, however, such as functional and or non-functional requirements, software assets are often not leveraged or reused effectively by architects to assist in providing more consistent architectural decisions.

The software patterns assets are often represented by a pattern specification and/or pattern implementation and these assets are often difficult to locate because of the lack of consistent and meaningful cataloging. Also, the knowledge and use of the asset, such as an industry model asset, is often local to a particular practitioner or architect. Hence, the consistency, traceable and accountability can be achieved by mapping nonfunctional requirements to patterns.

The majority of prior art adviser tools catalog assets according to requirement and understand the relationships between the assets and occurrences of the assets. The asset adviser tool can query a requirement hub and suggest the assets and or combinations of assets that can be utilized to satisfy the requirements. The tools can also suggest a best possible fit based on combinations of the requirement criteria but ultimately it will be up to an architect to review the assets suggested and make the final determination about which assets or combination of assets to utilize.

Therefore, a need exists for an improved asset adviser intelligence engine. Additionally, a need exists for providing a methodology, for modeling relationship between software requirement and the reusable software asset as disclosed in further detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for a method, system and computer-usable medium for managing reusable software assets.

It is a further aspect of the present invention to provide for a method, system and computer-usable medium for building domain information between software requirements and reusable software assets.

The aforementioned aspects and other objectives and advantages can now be achieved as described herein. A computer implemented method, system and computer program product for managing reusable software assets based on software requirements. A topic map can be expressed utilizing a semantic web technology in order to model a relationship between a software requirement and a reusable software asset. The relationship includes the software assets needed to satisfy the software requirement, relationship between the software assets, and the location of the software assets. The semantic web representation can then leverage a standard web based query mechanism to allow meaningful queries to suggest best software assets to be utilized with the software requirement. The semantic web representation can also leverage a standard XML (extensible markup language) based tool to provide consistence checking and inferencing of new data.

The topic maps can be modified and/or built and can be stored in a semantic web repository. A set of user requirements can be received and the asset requirement topic maps can be searched in order to understand best assets or combination of assets to be utilized for the set of user requirements. The relevant information about a particular asset can be found and the asset requirement maps can be maintained in order to keep the information up to date. Similarly, new information such as associations between using assets can be uncovered utilizing inference technology. The multiple views of the topic maps can also be provided based on roles.

An asset-requirement domain expert can built the topic maps and can navigate the entire map, create new association type or new topic types. The method disclosed in greater detail herein can be utilized to provide a novel, standard based, axiomatic, scalable and collaborative approach to a knowledge management problem of context matching between the requirement, that a user needs to address, and the assets that can be utilized to address the user requirements.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 depicts a graphical representation of a network of data processing systems in which aspects of the present invention may be implemented;

FIG. 4 illustrates a block diagram of a topic map, which can be utilized for modeling relationship between a software requirement and a reusable software asset, in accordance with a preferred embodiment;

FIG. 5 illustrates a block diagram of the overall workflow of an asset adviser intelligence engine for modeling relationship between the software requirement and the reusable software asset, in accordance with a preferred embodiment;

FIG. 6 illustrates a graphical user interface representation of an asset-requirement topic map based on semantic web technology, in accordance with a preferred embodiment;

FIG. 7 illustrates a UML class diagram indicative of an asset adviser intelligence engine hierarchy, in accordance with a preferred embodiment.

FIG. 8 illustrates a detailed flow chart of operations illustrating logical operational steps of a method for modeling relationship between a software requirement and a reusable software asset, in accordance with a preferred embodiment;

FIG. 9 illustrates a detailed flow chart of operations illustrating logical operational steps of a method for utilizing semantic web technology to represent the topic maps, in accordance with an alternative embodiment;

FIG. 10 illustrates a detailed flow chart of operations illustrating objectives of the present invention;

### DETAILED DESCRIPTION

The particular values and configurations discussed in these non-limiting examples can be varied and are cited merely to illustrate at least one embodiment and are not intended to limit the scope of such embodiments.

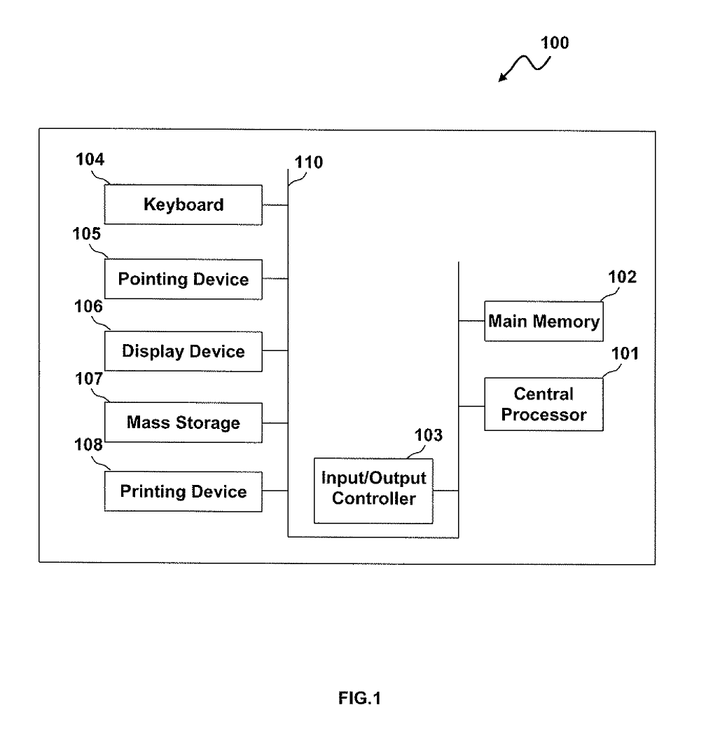

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the data-processing apparatus 100 as desired. As illustrated, the various components of the data-processing apparatus 100 communicate through a system bus 110 or similar architecture.

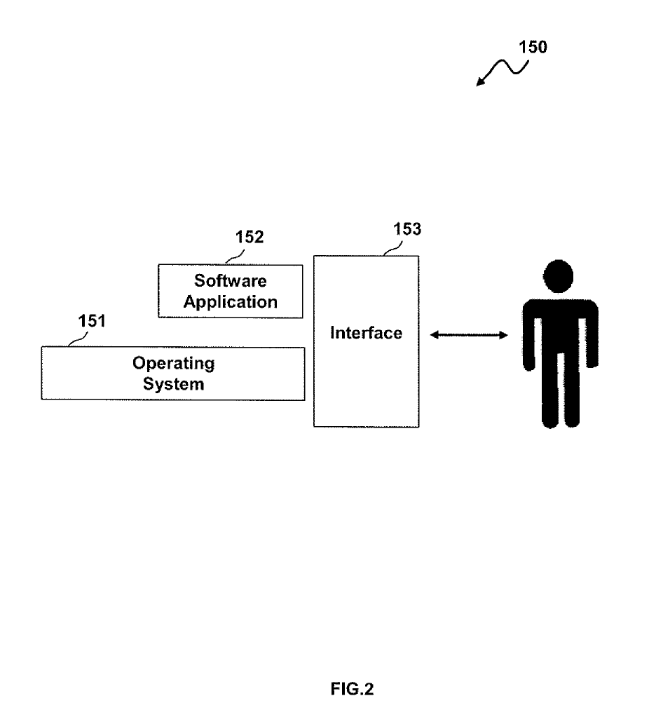

Illustrated in FIG. 2, a computer software system 150 is provided for directing the operation of the data-processing apparatus 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 152.

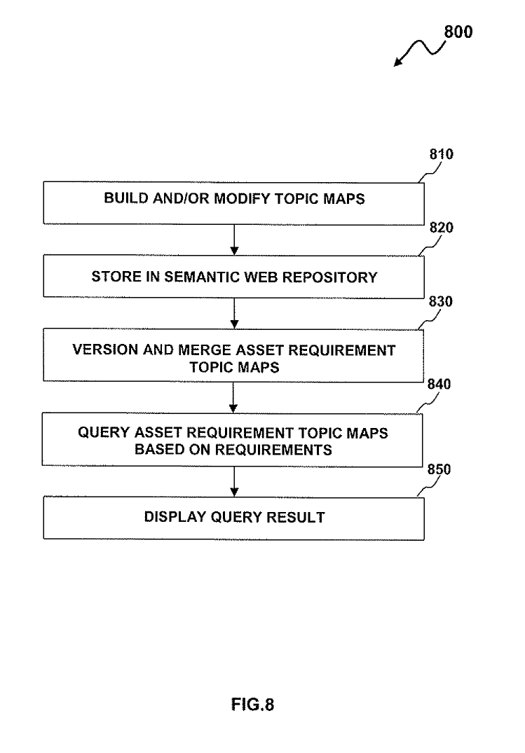

The interface 153, which is preferably a graphical user interface (GUI), also serves to display results, whereupon the user may supply additional inputs or terminate the session. In an embodiment, operating system 151 and interface 153 can be implemented in the context of a “Windows” system. Application module 152, on the other hand, can include instructions, such as the various operations described herein with respect to the various components and modules described herein, such as, for example, the method 800 depicted in FIG. 8.

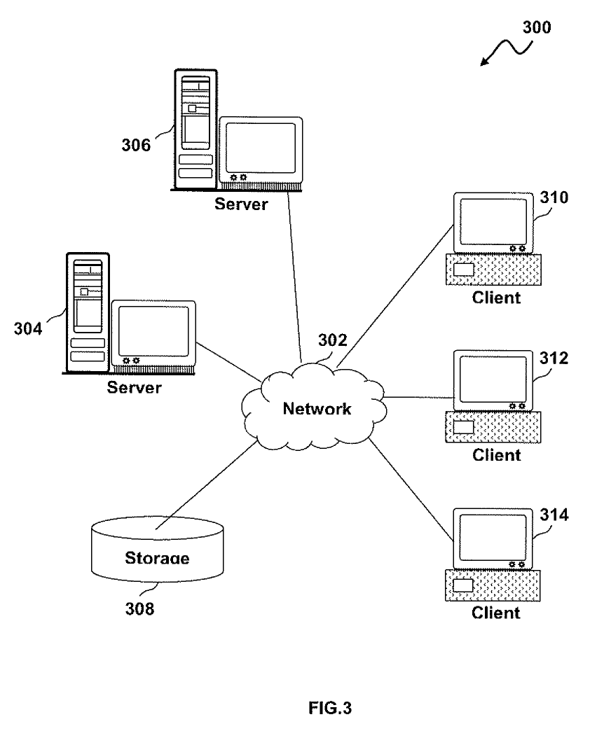

FIG. 3 depicts a graphical representation of a network of data processing systems in which aspects of the present invention may be implemented. Network data processing system 300 is a network of computers in which embodiments of the present invention may be implemented. Network data processing system 300 contains network 302, which is the medium used to provide communications links between various devices and computers connected together within network data processing apparatus 100. Network 102 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing apparatus 100 depicted in FIG. 1 can be, for example, a client such as client 310, 312, and/or 314. Alternatively, data-processing apparatus 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers, which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example, and not as an architectural limitation for different embodiments of the present invention.

The following description is presented with respect to embodiments of the present invention, which can be embodied in the context of a data-processing system such as data-processing apparatus 100, computer software system 150 and data processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

An asset is a collection of artifacts that provide a solution to a problem in context such as a requirement, a design model, implementation code, or a test case. A pattern can be a solution to a recurring problem in a given context. A pattern is a specific type of reusable asset. The distinction between the specification of the pattern such as a description of the problem, context, forces, and solution, and its implementation, such as a Java bean can be made. There can be many implementations of a single pattern specification. In general, a pattern asset or a reusable software asset, as utilized herein, refers to a set of related artifacts that have been created or harvested for the purpose of applying that asset repeatedly in subsequent development environments.

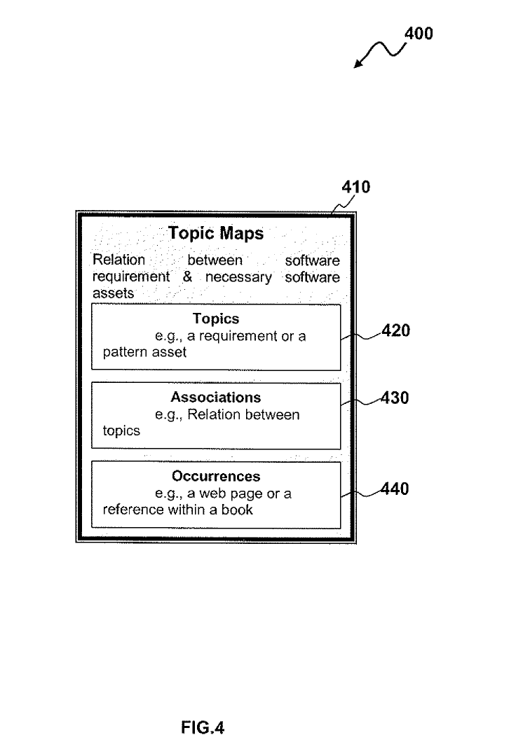

Referring to FIG. 4, a block diagram 400 of a topic map, which can be utilized for modeling relationship between a software requirement and a reusable software asset, is illustrated. Topic maps are an ISO standard for the representation and interchange of knowledge, with an emphasis on the findability of information. The standard is formally known as ISO/IEC 13250:2003. A topic map can represent information utilizing topics representing concepts such as software modules, individual files, and events, associations which represent the relationships between them, and occurrences which represent relationships between topics and information resources relevant to them. They are thus similar to semantic networks, concept maps and mind maps.

The topic map 410 can be utilized to model a relationship between the software requirement, which includes functional and nonfunctional requirements and the necessary software assets needed to satisfy the requirements. The structure of the topic map 410 includes a topic section 420, an association section 430 and an occurrence section 440. The topic section 420 defines a software requirement or a pattern asset as a topic. The association section 430 defines an association between the topics 420 for example, how a topic can be related to another and the occurrence section 440 provides occurrences of topics 420 for example, where topics can be found, such as a web page or a reference within a book, etc.

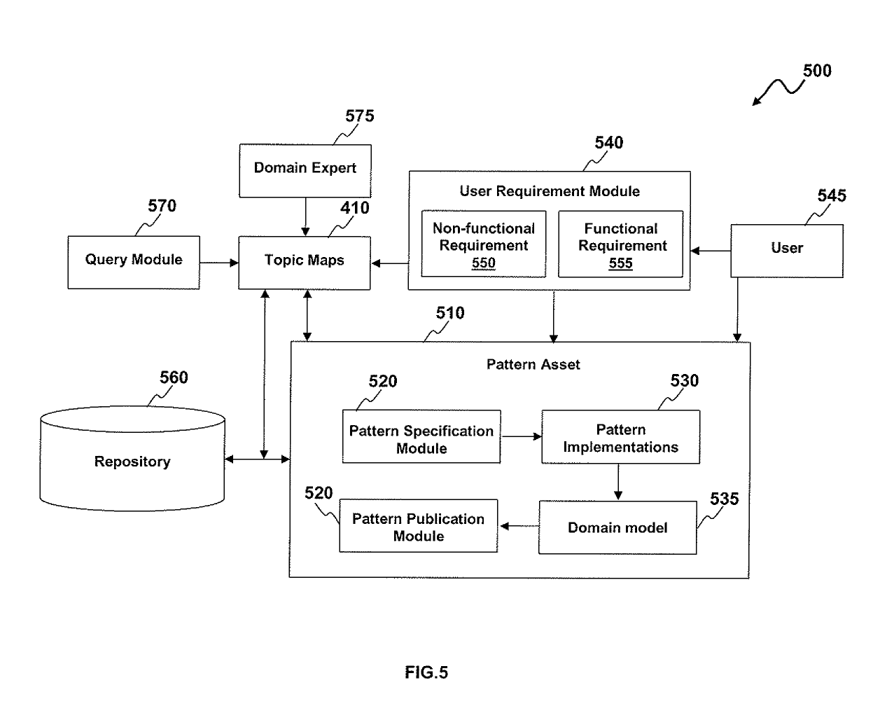

Referring to FIG. 5 a block diagram of the overall workflow of the asset adviser intelligence engine 500 for modeling relationship between the software requirement and the reusable software asset is illustrated. The asset adviser intelligence engine 500 includes a reusable software asset or a pattern asset 510 and a user requirement module 540. The user requirement module 540 can be classified as a functional requirement 550 and a non-functional requirement 555. The pattern asset 510 can optionally have a pattern specification module 520 that includes a document detailing a context, a problem and a repeatable solution addressed by the pattern asset 510. Patterns are a repeatable solution to a problem in context, and typically are described by the pattern specification module 520.

The pattern asset 510 possesses multiple pattern implementations 530 such as type of automation of the application of the pattern asset 510 based upon the pattern specification module 520. Feasibility for a solution is ultimately determined by nonfunctional requirements 550, examples of which are scalability, performance, security, transactionality, maintainability, and interoperability. The nonfunctional requirements 550 can be mapped to multiple pattern implementations 530 in the pattern specification 510 in order to achieve traceability and accountability in terms of architectural decisions. The pattern asset 510 provides a centralized resource for collecting the asset specification 520 and for publishing the pattern asset utilizing pattern publication module 520 to make the descriptions available to users 545.

An example for modeling the relationship between the non-functional requirements 550 and the pattern assets 510 and the occurrences 440 of the pattern assets 510 is illustrated in the following example. The non-functional requirements 550 specify global constraints that can be satisfied by the software. These constraints, also known as software global attributes, typically include performance, fault-tolerance, availability and security. Consider building an SOA (Service Oriented Architecture) informational service to allow CRUD (create, read, update, delete) access to customer information. The SOA includes different SOA patterns such as WS response template pattern, requester side caching pattern specification, preferred data source pattern and aspect logging pattern. Each of these SOA patterns satisfies certain non-functional requirements 550 typical to an SOA application. The SOA can be typically accessed by multiple different business process and the non-functional requirement 550 for this service is performance that can be addressed utilizing a requester side cache pattern. The relationship between the non-functional requirement and the pattern asset can be expressed as follows:

Performance (Non-functional Requirement)→Requester side cache (Pattern Asset)

The arrow (→) here can be labeled as ‘satisfied by’. Hence in topic maps 410 the performance and requester side cache can both be instances of topic 420 and the ‘associationinstance’ 430 between these two topics can be ‘satisfied by’. This approach can be utilized to build up complex associations between user requirements module 540 and pattern asset 510. For example, consider another topic instance WS response template. The WS response template pattern asset can be utilized to satisfy two types of non-functional requirements such as interoperability and flexibility. The relationship between the non-functional requirement and the pattern asset can be expressed as follows:

Interoperability (Non-functional Requirement)→WS Response Template (Pattern Asset)

Flexibility (Non-functional Requirement)→WS Response Template (Pattern Asset)

The arrow (→) here can be labeled as ‘satisfied by’. Also the WS Response Template pattern can be utilized with the requester side cache pattern and the relationship can be expressed as follows.

WS Response Template (Pattern Asset)→Requester side cache (Pattern Asset)

The arrow (→) here can be labeled as ‘used with’. Hence, in topic maps 410 the WS response template and the requester side cache can both be instances of topic 420 and the association instance 430 between these two topics can be ‘used with’. The pattern specification 520 and the associated pattern implementation 530 can be considered as occurrences 440 of the pattern asset 510. For example, the requester side cache pattern asset includes a pattern specification available as a web link-URL and two pattern implementations based on the pattern specification, which can be found in a RAS (reusable asset specification) repository. Thus:

Requester side cache (Pattern Asset)→Pattern Specification (Occurrence)

The arrow (→) here can be labeled, as ‘has occurrence’. The topic maps 410 can be expressed utilizing semantic web technology to collaboratively and dynamically build up a domain model 535 about the relationships between the software requirement module 540 and the reusable software pattern asset 510. The topic maps 410 related to the pattern assets 510 can be stored in a repository 560.

The repository 560 represents any data source such as storage 308 within an enterprise that stores information relevant to the management of reusable assets. The semantic web representation includes a query module 570 in order to allow meaningful queries to suggest best software pattern assets 510 to be utilized in accordance with the user requirement module 540. An asset-requirement domain expert 575 can build asset requirement topic maps 410, navigate the entire map 410 and create new association type or new topic types. The user 545 can see the relevant subset of the asset-requirements topic map 510 and pattern assets 510 relevant to the requirements.

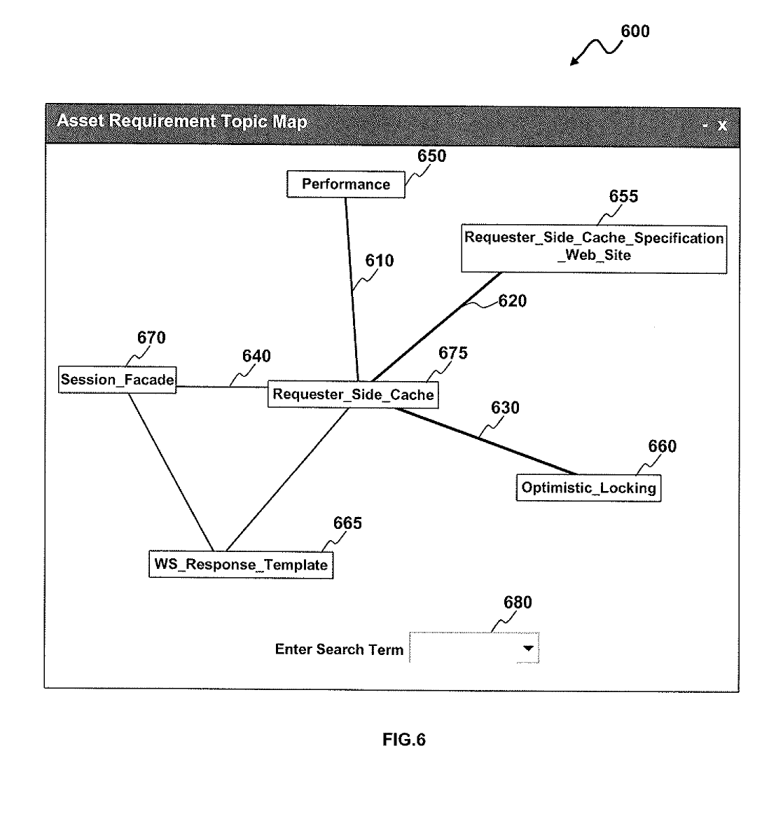

Referring to FIG. 6 an exemplary graphical user interface representation of an asset-requirement topic map 600 based on semantic web technology is illustrated, in accordance with a preferred embodiment. Note that in FIGS. 4-10, identical or similar blocks are generally indicated by identical reference numerals. The semantic web representation of the topic map 600 includes a requester_side_cache pattern 675 as pattern asset that can be ‘satisfied by’ the non-functional requirement, performance 650 as represented by line 610. The requester_side_cache 675 can be ‘used with’ Session_Facade 670 and WS_Response_Template 665 as represented by line 640.

Similarly, the line 620 represents a ‘has occurrence’ association 430 between requester_side_cache 675 and Requester_Side_Cache_Specification_Web_Site 655. The line 630 represents a ‘caution with’ association 430 between requester_side_cache 675 and Optimistic_Locking 660. The semantic web representation of the topic map 600 can then leverage a standard web based query mechanism 680 to allow meaningful queries to suggest best software assets to be utilized with the non-functional requirement, performance 650. The semantic web representation of the topic map 600 can also leverage a standard XML based tooling to provide consistence checking and inferencing of new data.

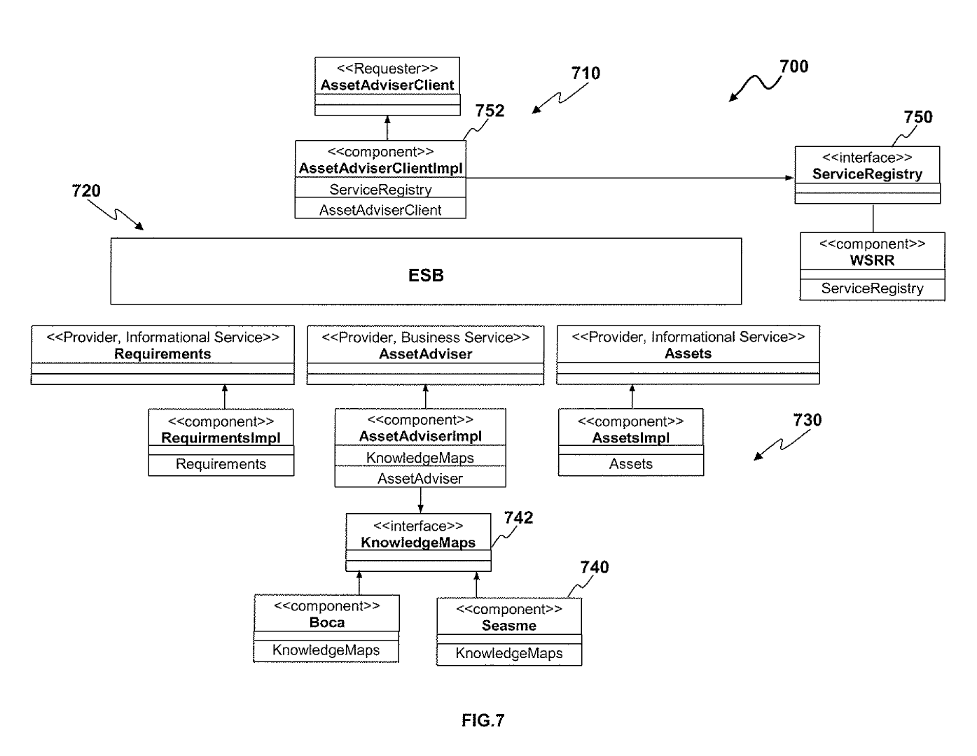

FIG. 7 illustrates a UML class diagram 700 indicative of an asset adviser intelligence engine hierarchy, in accordance with a preferred embodiment. The UML class diagram 700 includes an ESB (Enterprise Service Bus) 720 that can be provided as an abstract class through which a set of sub or derived classes can be made. The ESB 720 provides a connectivity infrastructure that can be utilized to integrate services within the SOA. The ESB 720 links between a service requester 710 such as a software requirement and a service provider 730 such as the reusable software assets. The ESB 720 takes responsibility for delivering its requests, utilizing messages, to the service provider 730 offering the required function and quality of service when the service requester 710 connects to the ESB 720. The ESB 720 facilitates requester-provider provider interactions and addresses despite mismatched protocols, interaction patterns or service capabilities. The ESB 720 can also enable or enhance monitoring and management and provides virtualization and management features that implement and extend the core capabilities of the SOA.

The service requester 710 and the service provider 730 include interfaces 750, 742 and components 740, 752 as AssetAdviser service, which permits the intelligence engine 500 to operate directly on class instances. The repository 560 as shown in FIG. 5 may store, for example, reusable software components 740, 752. The components 740, 752 are typically independently deployable code elements that often conform to a standardized component model, such as Enterprise JavaBeans (EJB) and the Component Object Model (COM). These components 740, 752 typically have well-defined interfaces 750, 742 that provide access to the encapsulated services or functions. An example of this type of repository includes a source code development environment that often stores the source code and the executable code within a repository to provide version control and to facilitate collaborative development.

Referring to FIG. 8 a detailed flow chart of operations illustrating logical operational steps of a method 800 for modeling relationship between the user requirement module 540 and the reusable software asset 510 is illustrated, in accordance with a preferred embodiment. Note that the method 800 depicted in FIG. 8 can be implemented in the context of a software module such as, for example, the application module 152 of computer software system 150 depicted in FIG. 2. The topic map such as topic maps 700 can be built and/or modified as OWL (Web Ontology Language) file, as shown at block 810. The OWL is a language for defining and instantiating web ontologies. The OWL ontology may include descriptions of classes, along with their related properties and instances. It can be designed for utilize by applications that need to process the content of information and facilitates greater machine interpretability of web content by providing additional vocabulary along with a formal semantics. OWL can be utilized as a major technology for the future implementation of a Semantic Web and plays an important role in an increasing number and range of applications, and is the focus of research into tools, reasoning techniques, formal foundations and language extensions.

The OWL file can be stored in a semantic web repository 560 such as a Sesame RDF (Resource Description Framework) server, as illustrated at block 520. Sesame RDF server is an open-source framework for querying and analyzing RDF data. A schema can be utilized to represent the topic maps 410 in OWL/RDF format. The asset requirements topic map 410 can initially be built utilizing a semantic web tool called Protégé. However a much more user friendly and constrained asset requirement topic map 410 can also be presented to the end user utilizing the present invention. The asset-requirement topic map 410 can allow the user 545 to create topics 420 such as pattern-asset topics and requirements topic etc and can create association 440 such as ‘satisfied by’, ‘used with’ etc. The following pseudo code illustrates an exemplary subsection of a asset-requirement topic map 410 OWL file showing details of the requester side cache topic:

<Topic rdf:ID=“Requester_Side_Cache”>
<locator rdf:datatype=“http://www.w3.org/2001/XMLSchema#anyURI”
>http://www-128.ibm.com/developerworks/webservices/library/wsrscp1/</
locator>
<subjectIdentifier
rdf:datatype=“http://www.w3.org/2001/XMLSchema#anyURI”
></subjectIdentifier>
<hasTopicName>
<TopicName rdf:ID=“Requester_Side_Cache_Topic_Name”>
<belongsToTopic rdf:resource=“#Requester_Side_Cache”/>
<hasScope>
<Scope rdf:ID=“Long_name”>
<belongsToTopicMap rdf:resource=“#Asset_Adviser”/>
<isScopeOf
rdf:resource=“#Requester_Side_Cache_Topic_Name”/>
<locator
rdf:datatype=“http://www.w3.org/2001/XMLSchema#anyURI”
>http://www.w3.org/2001/XMLSchema#string</locator>
</Scope>
</hasScope>
<hasScope>
<Scope rdf:ID=“Normal_name”>
<belongsToTopicMap rdf:resource=“#Asset_Adviser”/>
<locator
rdf:datatype=“http://www.w3.org/2001/XMLSchema#anyURI”
>http://www.w3.org/2001/XMLSchema#string</locator>
<isScopeOf
rdf:resource=“#Requester_Side_Cache_Topic_Name”/>
</Scope>
</hasScope>
<topicNameString
rdf:datatype=“http://www.w3.org/2001/XMLSchema#string”
>Requester Side Cache</topicNameString>
<hasVariant>
<Variant rdf:ID=“Requester_Side_Cache_Long_Name”>
<variantNameString
rdf:datatype=“http://www.w3.org/2001/XMLSchema#string”
>requester side caching pattern</variantNameString>
<isVariantOf
rdf:resource=“#Requester_Side_Cache_Topic_Name”/>
<variantScope rdf:resource=“#Long_name”/>
<locator
rdf:datatype=“http://www.w3.org/2001/XMLSchema#anyURI”
>http://www.w3.org/2001/XMLSchema#string</locator>
</Variant>
</hasVariant>
</TopicName>
</hasTopicName>
<playsRole rdf:resource=“#Pattern_is_Requester_Side_Cache”/>
<belongsToTopicMap rdf:resource=“#Asset_Adviser”/>
<hasOccurrence>
<Occurrence rdf:ID=“Infomational_Service”>
<occurrenceOfTopic rdf:resource=“#Requester_Side_Cache”/>
<occurrenceTextString
rdf:datatype=“http://www.w3.org/2001/XMLSchema#string”
>Controller Layer</occurrenceTextString>
<type>
<OccurrenceType rdf:ID=“SOA_Context”>
<belongsToTopicMap rdf:resource=“#Asset_Adviser”/>
<locator
rdf:datatype=“http://www.w3.org/2001/XMLSchema#anyURI”
>http://www-
128.ibm.com/developerworks/websphere/techjournal/0508_simmons/
0508_simmons.html</locator>
</OccurrenceType>
</type>
</Occurrence>
</hasOccurrence>
</Topic>

The asset requirement topic maps 410 can be versioned and merged, as shown at block 830. The topic maps 410 can be built by different domain experts 575 and can be organized in conceptual spaces according to meaning. For example, the domain expert 575 can build the asset-requirements topic map 410 in an SOA information service space and another domain expert 575 can build one up in an integration services space and both the maps can be easily merged together. The topic maps 410 can be queried based on user requirements 540, as shown at block 840. The result can then be displayed, as indicated at block 850.

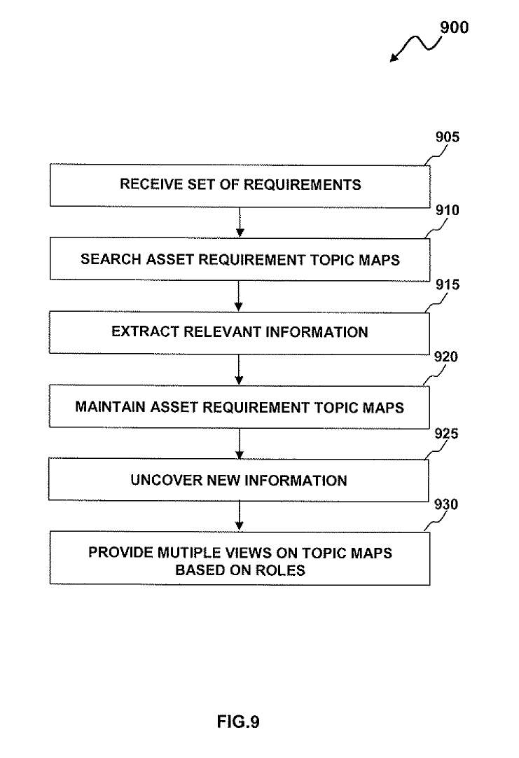

Referring to FIG. 9, a detailed flow chart of operations illustrating logical operational steps of a method 900 for utilizing semantic web technology to represent the topic maps is illustrated, in accordance with an alternative embodiment. Note that in FIGS. 4-10, identical or similar blocks are generally indicated by identical reference numerals. A set of requirements can be received by the user requirement module 540, as illustrated at block 905. The asset requirement topic maps 410 stored in the repository 560 can be searched in order to understand best assets or combination of assets to be utilized for the particular set of requirements.

The relevant information about a particular asset such as the location of the asset and assets that can be utilized in conjunction with another asset can be extracted, as depicted at block 915. The asset requirement topic maps 410 can be maintained in order to keep information up to date, as shown at block 920. Thereafter, as depicted at block 925, new information such as associations between using assets can be uncovered utilizing inference technology. The multiple views of the topic maps 410 can be provided based on roles, as illustrated at block 930.

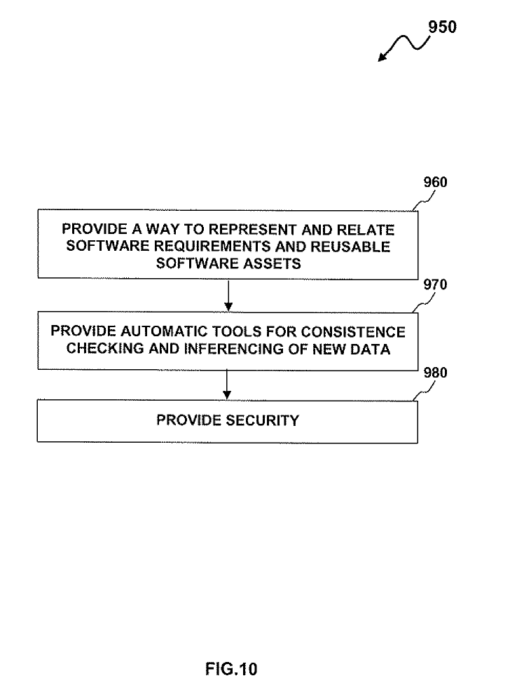

FIG. 10 illustrates a detailed flow chart 950 of operations illustrating objectives of the present invention. The asset adviser intelligence engine 500 provides a way to represent and relate the user requirements 540 and the reusable software asset 510, as shown at block 960. Thereafter, automatic tools for consistence checking and inferencing of new data can also be provided, as illustrated at block 970. The semantic web XML/RDF based query languages, such as SparQL can be utilized for meaningful query answering across the asset-requirements topic maps 410. The selection of the RDF based repository like Sesame provides support for this kind of querying. The following example utilize SparQL query that can be utilized to satisfy the performance, non-functional requirement.

PREFIX foaf: <http://www.eoinlane.com/owl/assetadviser.owl#>
SELECT ?playsRole
WHERE {
?playsRole foaf:playsRole ?roleInAssociation .
?roleInAssociation foaf:roleInAssociation ?hasRole .
?hasRole foaf:hasRole ?playedBy .
?playedBy foaf:playedBy foaf:Performance
}

The asset adviser intelligence engine 500 also provides security by utilizing XML security based standards, as depicted at block 980. Note that the methods 800 and 900 can be implemented in the context of a computer-useable medium that contains a program product. The methods 800 and 900 depicted in FIG. 8-9 can also be implemented in a computer-usable medium containing a program product. The method disclosed in greater detail herein can be utilized to provide a novel, standard based, axiomatic, scalable and collaborative approach to a knowledge management problem of context matching between the requirement, that the architect needs to address, and the assets that can be used to address these requirements.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the methods 800 and 900 described herein can be deployed as process software in the context of a computer system or data-processing system as that depicted in FIGS. 1-3.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method comprising:
configuring a plurality of topic maps by a domain expert for modeling a relationship between a software requirement and at least one software pattern asset utilizing a semantic web technology and storing said topic map in a repository;
receiving a set of user requirements and searching said plurality of topic maps stored in said repository based on said set of user requirements and suggesting said at least one software pattern asset for reuse thereto, wherein said at least one reusable asset; and
thereafter extracting relevant information associated with said set of user requirements wherein said relevant information includes said at least one reusable asset required to satisfy said set of user requirements, said relationship between said at least one pattern and said at least one software pattern, and a location of said at least one pattern.

2. The computer-implemented method of claim 1 wherein said repository comprises a Web repository.

3. The computer-implemented method of claim 1 wherein said at least one reusable asset comprises a pattern asset.

4. The computer-implemented method of claim 3 wherein said pattern asset comprises a pattern specification and a pattern implementation.

5. The computer-implemented method of claim 1 further comprising;
querying said plurality of topic maps in order to suggest said at least one software pattern asset to be utilized in accordance with said set of user requirements; and
versioning and merging said plurality of topic maps organized in a conceptual space in accordance with a particular meaning.

6. The computer-implemented method of claim 1 wherein at least one topic map among said plurality of topic maps creates at least one topic, an association between said at least one topic and a particular occurrence of said at least one topic.

7. The computer-implemented method of claim 1 wherein said semantic web technology is capable of leveraging an XML tool in order to provide constancy in checking and inferencing of new data.

8. The computer-implemented method of claim 1 wherein said at least one software pattern asset comprises at least one of the following: a requester side cache pattern, a WS response template pattern, a preferred data source pattern and an aspect logging pattern.

9. The computer-implemented method of claim 1 wherein said repository comprises a Sesame RDF (Resource Description Framework) server.

10. The computer-implemented method of claim 1 wherein said topic map comprises OWL (Web Ontology Language) file.

11. A system, comprising:
a data bus coupled to said processor; and
a computer-usable medium embodying computer code, said computer-usable medium being coupled to said data bus, said computer program code comprising instructions executable by said processor and configured for:
configuring a plurality of topic maps by a domain expert for modeling a relationship between a software requirement and at least one software pattern asset utilizing a semantic web technology and storing said topic map in a repository;
receiving a set of user requirements and searching said plurality of topic maps stored in said repository based on said set of user requirements and suggesting said at least one software pattern asset for reuse thereto, wherein said at least one reusable asset; and
thereafter extracting relevant information associated with said set of user requirements wherein said relevant information includes said at least one reusable asset required to satisfy said set of user requirements, said relationship between said at least one pattern and said at least one software pattern, and a location of said at least one pattern.

12. The system of claim 11, wherein said instructions are further configured for:
querying said plurality of topic maps in order to suggest said at least one software pattern asset to be utilized in accordance with said set of user requirements; and
versioning and merging said plurality of topic maps organized in a conceptual space in accordance with a particular meaning.

13. The system of claim 11, wherein at least one topic map among said plurality of topic maps creates at least one topic, an association between said at least one topic and a particular occurrence of said at least one topic.

14. The system of claim 11 wherein said semantic web technology is capable of leveraging an XML tool in order to provide constancy in checking and inferencing of new data.

15. A computer-usable medium embodying computer program code, said computer program code comprising computer executable instructions configured for:
configuring a plurality of topic maps by a domain expert for modeling a relationship between a software requirement and at least one software pattern asset utilizing a semantic web technology and storing said topic map in a repository;
receiving a set of user requirements and searching said plurality of topic maps stored in said repository based on said set of user requirements and suggesting said at least one software pattern asset for reuse thereto, wherein said at least one reusable asset; and
thereafter extracting relevant information associated with said set of user requirements wherein said relevant information includes said at least one reusable asset required to satisfy said set of user requirements, said relationship between said at least one pattern and said at least one software pattern, and a location of said at least one pattern.

16. The computer-usable medium of claim 15, wherein said embodied computer program code further comprises computer executable instructions configured for:
querying said plurality of topic maps in order to suggest said at least one software pattern asset to be utilized in accordance with said set of user requirements; and
versioning and merging said plurality of topic maps organized in a conceptual space in accordance with a particular meaning.

17. The computer-usable medium of claim 15, wherein at least one topic map among said plurality of topic maps creates at least one topic, an association between said at least one topic and a particular occurrence of said at least one topic.

18. The computer-usable medium of claim 15, wherein said semantic web technology is capable of leveraging an XML tool in order to provide constancy in checking and inferencing of new data.

19. The computer-usable medium of claim 15, wherein said at least one software pattern asset comprises at least one of the following: a requester side cache pattern, a WS response template pattern, a preferred data source pattern and an aspect logging pattern.

20. The computer-usable medium of claim 15, wherein said repository comprises a Sesame RDF (Resource Description Framework) server and wherein said topic map comprises OWL (Web Ontology Language) file.
